(19) United States
(12) Patent Application Publication
(10) Pub. No.: US 2026/0064822 A1
(43) Pub. Date: Mar. 5, 2026

(54) CONTAINER-BASED BASEBOARD MANAGEMENT CONTROLLERS

(71) Applicant: Hewlett Packard Enterprise Development LP, Spring, TX (US)

(72) Inventors: Wan-Yen Hsu, Cupertino, CA (US); Chih-Hao Chang, Taipei City (TW); Paresh Sao, Bangalore (IN); Nisha Agarwal, Bangalore (IN)

(21) Appl. No.: 18/935,915

(22) Filed: Nov. 4, 2024

(30) Foreign Application Priority Data
Sep. 4, 2024 (IN) 202411066990

(51) Int. Cl. G06F 21/44

(52) U.S. Cl. CPC G06F 21/44

(57) ABSTRACT

A baseboard management controller operates independently from an operating system of a host to manage the host. The baseboard management controller includes a hardware processor. The hardware processor causes the baseboard management controller to provide a plurality of software containers to provide services to manage the host. The hardware processor causes the baseboard management controller to provide an execution control engine to manage lifecycles of the software containers.

### BACKGROUND

A computer platform (e.g., a server) may include a specialized service subsystem, called a "baseboard management controller" (or "BMC"), which monitors the physical state of the computer platform. A baseboard management controller may communicate with a remote management server through a management network for purposes of reporting information about the computer platform and allowing the remote management server to control actions that are performed by the baseboard management controller.

### BRIEF DESCRIPTION OF THE DRAWINGS

FIG. 1 is a block diagram of a computer platform that includes a baseboard management controller that has a zero trust, containerized microservices platform, according to an example implementation.

FIG. 2 is a block diagram of a zero trust microservices architecture for a baseboard management controller according to an example implementation.

FIG. 3 is a sequence flow diagram depicting actions performed by components of a zero trust microservices platform to respond to a run container request, according to an example implementation.

FIG. 4 is a sequence flow diagram depicting on-demand creating and starting of a container by components of a zero trust microservices platform according to an example implementation.

FIG. 5 is a sequence flow diagram depicting actions and communications of components of a zero trust microservices platform responsive to a container object being modified, according to an example implementation.

FIG. 6 is a block diagram of an apparatus that includes a baseboard management controller to provide and manage containers to provide services, according to an example implementation.

FIG. 7 is an illustration of instructions that are stored on a non-transitory hardware processor-readable storage medium and, when executed by a hardware processor of a management controller, cause the management controller to validate and run a container, according to an example implementation.

FIG. 8 is a flow diagram depicting a technique performed by a baseboard to host and manage a container based on a zero trust policy, according to an example implementation.

### DETAILED DESCRIPTION

A baseboard management controller may perform a wide variety of management-related services for a computer platform. In an example, the management services include monitoring an operating system of the computer platform. In another example, the management-related services include detecting and initializing resources of the computer platform. In other examples, the management-related services include monitoring sensors (e.g., temperature sensors, cooling fan speed sensors); reporting out-of-range sensor readings; and logging computer system events. The management-related services may also include services that are remotely-managed (e.g., managed by a management server in a different datacenter than the computer platform or in a different geographical location than the computer platform). In examples, the remotely-managed services may include keyboard video mouse (KVM) services; virtual power services (e.g., services to place the computer platform in a particular power state, such as a power conservation state, a power on state, a reset state or a power off state); and services to manage virtual media.

In addition to providing management-related services, a baseboard management controller may provide security-related services for a computer platform. As examples, a baseboard management controller may provide such security-related services as validating firmware; securely storing cryptographic artifacts (e.g., cryptographic keys, passwords and digital certificates); applying cryptographic hash algorithms; performing encryption; performing decryption; detecting tampering; and other services related to protecting the computer platform against security intrusions.

In one approach, a baseboard management controller has firmware and dedicated hardware to provide a suite of management-related and security-related services. The firmware may include a firmware management stack, which is executed by the baseboard management controller to provide management-related services. The firmware management stack is monolithic in nature, as modifying the firmware management stack to add, delete or change management-related services involves replacing an entire firmware image. Over time, there may be reasons (e.g., the introduction of a new computer platform product, a customer request or an industry change) to change the services that are available for a particular baseboard management controller version. Implementing such changes may, however, be associated with lengthy delays. In this manner, any service change may involve first building and testing the change before the change is released into production. Building and testing updates may introduce significant delays in implementing the service change. Moreover, implementing the service change corresponds to replacing or updating the current firmware image. Additionally, the current version of the baseboard management controller may not support certain service changes, and therefore, some service changes may be unavailable until the next baseboard management controller version is released.

In accordance with example implementations that are described herein, a baseboard management controller has a containerized, zero trust microservices platform. Unlike a design in which services of a baseboard management controller are monolithic in nature (e.g., management-related services are encoded into a monolithic management firmware stack), services of a baseboard management controller, in accordance with example implementations, are provided as corresponding autonomous parts called "microservices." Accordingly, a given microservice (corresponding to a particular service) may be modified, replaced or deleted independently from the other microservices. This agility and flexibility allow service changes to be introduced without incurring lengthy delays or waiting for an updated new version of the baseboard management controller to be released.

Depending on the particular implementation, the zero trust microservices platform may provide microservices that correspond to management-related services, security-related services or a combination of management-related services and security-related services. In the following discussion, unless otherwise specified, it is assumed that a "service" provided by the zero trust microservices platform may either be a management-related service or a security-related service.

The microservices are provided by instantiated containers (also referred to herein as "containers" or "software containers") that are hosted and managed by the baseboard management controller's zero trust microservices platform. In an example, a single container provides a microservice that corresponds to a particular service for the baseboard management controller. In another example, the baseboard management controller's zero trust microservices platform hosts multiple containers that respectively provide multiple microservices that correspond to respective services for the baseboard management controller. In another example, multiple containers corroborate to provide a particular service for the baseboard management controller. In a more specific example, a cluster of orchestrated containers (e.g., a KUBERNETES cluster or DOCKER SWARM cluster) provides one or multiple microservices that correspond to respective services for the baseboard management controller. Continuing the example, the cluster has a control plane and worker nodes, each worker node contains one or multiple container pods, and each pod includes multiple containers. In an example, a worker node contains multiple pods, and each pod corresponds to an instance of the same microservice.

In the context that is used herein, the "zero trust" nature of the microservices platform means that the platform initially assumes that all containers are untrustworthy, or compromised. This initial assumption is, in accordance with example implementations, overcome for a particular container by the zero trust microservices platform validating the container, and the container passing the validation. Once successfully validated, the now trusted container may be run and hosted on the zero trust microservices platform. As described herein, the zero trust microservices platform validates a container by verifying one or multiple container objects (e.g., a container image, a library, an executable file or other object) that are associated with the container. A particular container is deemed trustworthy when all of the container object(s) associated with the container are successfully verified. In accordance with example implementations and as further described herein, the zero trust microservices platform includes an execution control engine that control's the platform's response to application programming interface (API) requests in a way that ensures that no untrusted container is run on the platform.

Among the potential benefits of the zero trust microservices architecture, new services for a based baseboard management controller may be readily added by deploying new containers on the platform. The containers may be implemented, tested and released independently from one another. Moreover, the containers may be run and stopped independently from one another, and containers may be run or stopped dynamically to accommodate specific customer criteria. Resource constraints may be specifically tailored for each container to prevent resource drain for the entire baseboard management controller. The containers provide isolation, which enhances security and confines risks or vulnerabilities to individual containers without otherwise impacting other containers or the entire baseboard management controller.

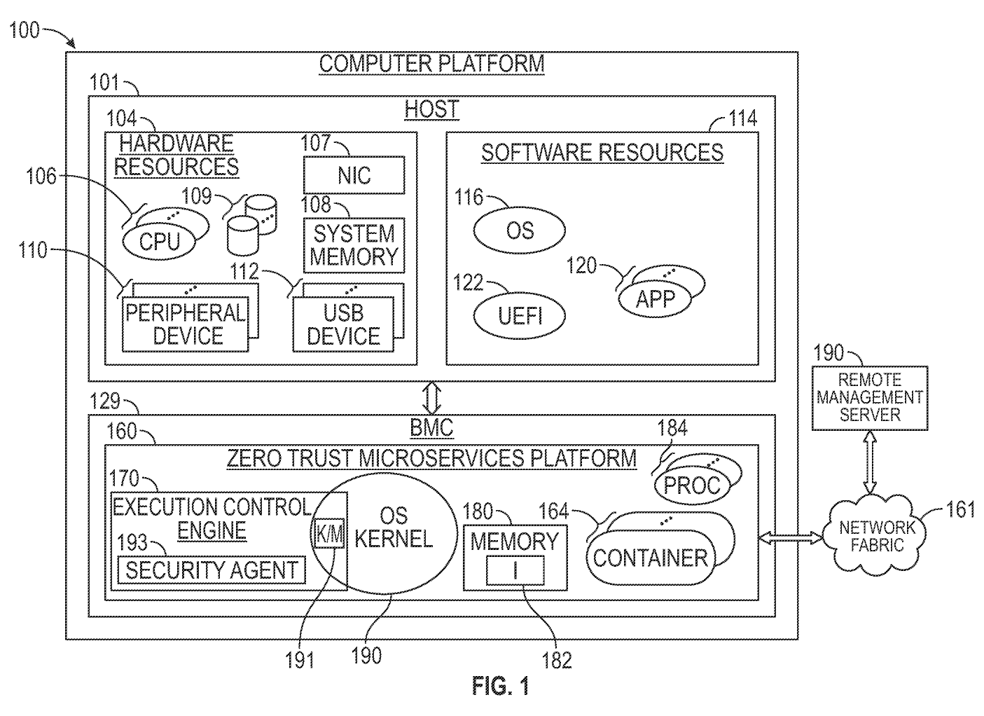

Referring to FIG. 1, as a more specific example, in accordance with example implementations, a computer platform 100 includes a host 101 and a baseboard management controller 129. In this context, a "computer platform" refers to a unit that includes a chassis and hardware that is mounted to the chassis, where the hardware is capable of executing machine-readable instructions (or "software"). In examples, a computer platform 100 may be an enclosure-based server (e.g., a blade server), a rack-based server (e.g., a density line (DL) server), or a tower server. In other examples, a computer platform 100 may be a client, a desktop computer, a smartphone, a storage array, a network device, a smart television, a laptop computer, a tablet computer, wearable computer or any other processor-based device.

In the context that is used herein, a "host" refers to an entity that has an unabstracted view of resources of a computer platform. The computer platform 100 may include one or multiple hosts 101. For multiple hosts 101, the baseboard management controller 129 may manage each of the hosts 101. For the example implementation that is depicted in FIG. 1, the resources of the host 101 include hardware resources 104, such as one or multiple central processing unit (CPU) cores 106; a system memory 108; one or multiple peripheral devices 110 (e.g., Peripheral Component Interconnect express (PCIe) cards and/or Compute Express Link (CXL) cards); one or multiple network interface controllers (NICs) 107; one or multiple storage devices 109; one or multiple Universal Serial Bus (USB) devices 112; as well as other and/or different actual, or physical, components.

In general, the memory devices that form the system memory 108, as well as other memories and storage media that are described herein, are examples of non-transitory machine-readable storage media. In accordance with example implementations, the machine-readable storage media may be used for a variety of storage-related and computing-related functions of the computer platform 100. As examples, the memory devices may include semiconductor storage devices, flash memory devices, memristors, phase change memory devices, magnetic storage devices, a combination of one or more of the foregoing storage technologies, as well as memory devices based on other technologies. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

The resources of the host 101 also include software resources 114. For the example implementation that is depicted in FIG. 1, the software resources 114 include an operating system 116, a Unified Extensible Firmware Interface (UEFI) 122, one or multiple applications 120, as well as other and/or different components that are created by the execution of machine-readable instructions by the CPU cores 106. The applications 120 may execute in one or multiple application operating environments, such as bare-metal environments, virtual machines, containers, and so forth.

The services that are provided by baseboard management controller 129, in general, "manage" the host 101. A given service may be classified as being a management-related service associated with a management plane of the baseboard management controller 129, or the given service may be classified as being a security-related service associated with a security-related plane of the baseboard management controller 129. Some of the services may be monitored and managed by a remote management server 190. In this manner, the remote management server 190 may include a graphical user interface (GUI), or dashboard, for purposes of displaying information and alerts provided by the baseboard management controller 129 as well as providing user controls to manage the services and invoke certain functions (e.g., virtual media functions, power functions and KVM functions) of the baseboard management controller 129. As depicted in FIG. 1, in accordance with example implementations, the baseboard management controller 129 may be connected to the remote management server 190 via physical network fabric 161. In general, the physical network fabric 161 may be associated with one or multiple types of communication networks, such as, in examples, Fibre Channel networks, CXL fabric, dedicated management networks, local area networks (LANs), WANs, wireless networks, or any combination thereof.

As used herein, a "baseboard management controller" (or "BMC") is a specialized service processor subsystem that monitors the physical state of a server or other hardware using sensors and communicates with a management system through a management network. The baseboard management controller may communicate with applications executing at the operating system level through an input/output controller (IOCTL) interface driver, a representational state transfer (REST) application program interface (API), or some other system software proxy that facilitates communication between the baseboard management controller and applications. The baseboard management controller may have hardware level access to hardware devices of the host of the computer platform, including system memory. The baseboard management controller may be able to directly modify the hardware devices. The baseboard management controller may operate independently of the operating system of the computer platform. The baseboard management controller may be located on the motherboard or main circuit board of the computer platform.

The fact that a baseboard management controller is mounted on a motherboard of the computer platform or is otherwise connected or attached to the computer platform does not prevent the baseboard management controller from being considered "separate" from the host of the computer platform. As used herein, a baseboard management controller has management capabilities for sub-systems of a computer platform and is separate from the processing resources that execute an operating system of the computer platform.

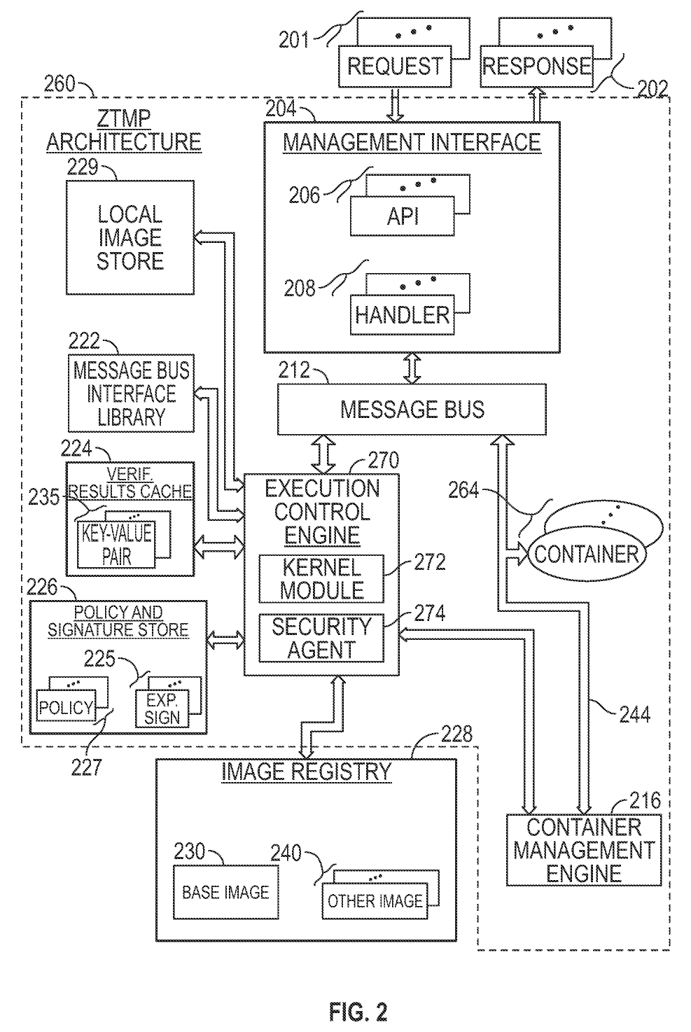

The baseboard management controller 129 includes a zero trust microservices ecosystem, or platform 160, which hosts containers 164 for purposes of providing various microservices. The zero trust microservices platform 160 is a container execution environment that assumes that no container is trustworthy until the container is successfully validated (also referred to herein as the container being successfully "verified"). Moreover, in accordance with example implementations, the container validation is for purposes of a single instance of running a trusted container 164, and after a container 164 stops running, the zero trust microservices platform 160 once again assumes no trust and applies the validation process again for a subsequent request to run the container. As described herein, the "container 164" refers to a validated and trusted container that is running on the zero trust microservices platform 160 (as compared to, for example, a container that may be under evaluation and but is not yet running on the platform 160). The zero trust microservices platform 160 has a corresponding architecture that is depicted in an example implementation and described below in connection with FIG. 2.

Still referring to FIG. 1, in an example, the microservices that are provided by the containers 164 correspond to both management-related services and security-related services that are provided by the baseboard management controller 129 for the host 101. In another example, the microservices correspond to management-related services provided by the baseboard management controller 129 for the host 101, and the baseboard management controller 129 includes a secure enclave to provide security-related services for the host 101. In an example, a given single container 164 provides a microservice that corresponds to a particular service that is provided by the baseboard management controller 129. In another example, multiple containers 164 provide multiple respective services of the baseboard management controller 129 for the host 101. In another example, multiple orchestrated containers 164 (e.g., a KUBERNETES cluster) corroborate to provide one or multiple microservices that correspond to respective services of the baseboard management controller 129. In another example, the zero trust microservices platform 160 hosts a collection of containers 164, where one or multiple individual containers 164 of the collection provide respective microservices, and one or multiple container clusters of the collection provide microservices.

In this context that is used herein, a "container" (also called an "instantiated container," "container instance, or "software container" herein), such as the container 164, generally refers to a virtual run-time environment for one or multiple applications and/or application modules. This virtual run-time environment is constructed to interface to an operating system kernel, such as an example operating system kernel 190 of the baseboard management controller 129 that is depicted in FIG. 1. A container 164 may, for example, contain executable code and its dependencies of the executable code, such as system tools, libraries, configuration files and executable files. In accordance with example implementations, the container 164 contains an operating system kernel mount interface but does not include the operating system kernel 190. In accordance with example implementations, the containers 164 share an operating system kernel through respective operating system kernel mount interfaces. Docker containers, containerd containers and rkt containers are examples of the containers 164.

The container 164 is a run-time entity that has a corresponding overlay file system. The overlay file system has a layered file system structure, which includes lower layers that correspond to a container image and an upper layer that serves as the workspace for the file system. In an example, an instantiated container 164 is created by the combination of a load container image request followed by a container run request. Multiple instantiated containers 164 may be created from the same container image. Moreover, as described further herein, multiple containers 164 may share a base image corresponding to lower layers of the container image.

Additionally, as further described herein, the baseboard management controller 129 may perform "lazy loading" for containers 164. In this context, "lazy loading" refers to a technique in which processes associated with a container are loaded and started, without loading and starting other processes associated with the container. In an example, a controller loop process associated with a container is first loaded into memory and started. The controller loop process monitors processing requests and needs by monitoring events, exceptions and notifications. Based on the requests and needs, the controller loop determines which additional processes are to be loaded and started to satisfy the requests and needs. Moreover, the controller loop process controls the removal of the processes when no longer needed, thereby freeing up memory.

The container image forms immutable layers of a container's overlay file system. Here, the "immutable" nature of the container image means that the container image and the corresponding lower layers of the overlay file system formed from the container image are supposed to be read-only (i.e., are not supposed to be modified). The container image contains directories, files, executables, libraries, and so forth. A base layer of the container image contains a root file system (i.e., contains the root file directory and files) and basic configuration for the root file system (e.g., the entry point of the root file system, environment variables, and so forth). The container image may also contain one or multiple layers (called "intermediate layers") above the base layer. Collectively, the layers of the container image form a layered file system.

In accordance with example implementations, the zero trust microservices platform 160 includes an execution control engine 170. In general, the execution control engine 170 manages the lifecycles of containers 164 based on a zero trust policy. In this context, managing the lifecycle of a container refers to managing at least some part of the container's creation, deployment, and operation. In accordance with example implementations, the execution control engine 170 enforces the zero trust policy of the zero trust microservices platform 160 by ensuring that a container does not run until the container is successfully validated (and therefore, determined to be trustworthy).

Authorized clients of the baseboard management controller 129 may submit container-related API requests to the basement management controller 129. Some API requests may be directed to container operations. In an example, an API request directed to a container operation may be a request (called a "run container request" herein) to create and start a container. In another example of a request directed to a container operation, an API request may be a request (called a "stop container request" herein) to halt, or stop, a container. In another example of a request directed to a container operation, an API request may be a request (called an "image pull request" herein) to transfer a container image from an image registry to a local container image store for the baseboard management controller. In another example, an API request may be a request (called an "image removal request" herein) to remove an image from the baseboard management controller's local image store. In other examples, API requests may be directed to creating, starting, resuming, pausing and restarting containers.

Other API requests may not be strictly container operation requests, but may nevertheless be intended to modify, replace or delete objects that are associated with containers. In examples, API requests may be intended to modify, replace or delete libraries or executable files that are associated with containers.

The zero trust microservices platform 160 assumes that all containers are inherently untrusted until the containers are first successfully validated by the platform 160. Consequently, the execution control engine 170 does not allow any container to run until the engine 170 first successfully validates the container.

The execution control engine 170, in accordance with example implementations, includes a kernel module 191 that is part of an operating system kernel 190 of the zero trust microservices platform 160. In an example, the operating system kernel 190 is a LINUX operating system kernel, and the kernel module 191 is a LINUX Security Module (LSM). The kernel module 191, in accordance with example implementations, intercepts API requests that correspond to container lifecycle operation calls. A run container request (e.g., a DOCKER "runc" run container request or a REDHAT "crun" run container request) to run a container having a certain container ID is an example of a container lifecycle operation call that is intercepted by the kernel module 191. In other examples, the kernel module 191 intercepts other types of lifecycle operation calls, such as calls to create, resume and restart container. In accordance with some implementations, the kernel module 191 is configured by default to intercept certain lifecycle operation calls (e.g., calls to create, start, run, resume or restart containers), and the kernel module 191 may be configured by policy to intercept other lifecycle operation calls. In examples, these other lifecycle operation calls include one or multiple of the following: pause container calls, stop container calls, remove container calls, load archived container calls, checkpoint container calls as well as possibly other calls.

The kernel module 191, in accordance with example implementations, does not allow an intercepted container lifecycle operation call to proceed and be executed until the container that is targeted by the container lifecycle operation call is first successfully validated. In this manner, the kernel module 191 blocks, or prevents, the container lifecycle operation call from executing responsive to the container failing validation, and the kernel module 191 allows the container lifecycle operation call to execute responsive to the container passing validation.

In accordance with example implementations, the validation of a container for a particular container lifecycle operation, involves verifying a collection of one or multiple objects (called "container objects" herein) that are associated with the container. As further described herein, the verification of the container object(s) may involve the kernel module 191 checking a verification results cache and may involve the kernel module 191 using a security agent 193 of the execution control engine 170 to verify one or multiple container object signatures. The number (one or more than one) of container objects to be verified for a particular container may depend on a container validation policy for the execution control engine 170. If all of the container objects for a particular container pass their respective verifications, then the kernel module 191 trusts the container and allows the container lifecycle operation call to proceed. Otherwise, the kernel module 191 blocks the container lifecycle operation.

In an example, the security agent 193 corresponds to a background process, or daemon, which executes outside of the operating system kernel 190. In accordance with example implementations, the security agent 193 provides a supporting container object verification function for the kernel module 191 when requested to do so by the kernel module 191. In accordance with example implementations, the security agent 193 verifies a particular container object by determining whether an observed integrity measurement of the container object matches (or is the same as) an expected integrity measurement for the container object. In an example, the observed and expected integrity measurements may be cryptographic digests, or hashes, which are referred to herein as "signatures." The security agent 193 verifies a particular container object by determining whether an observed signature for the container object matches (e.g., is the same as) an expected signature for the container object. The security agent 193 determines an observed signature for a container object by applying a cryptographic hash algorithm to the container object. In an example, the expected signature for a container object is stored in a trusted signature store of the zero trust microservices platform 160. In another example, the expected signature for a container object is included as a parameter in an API request (e.g., included in a container lifecycle operation call).

In an example, a container object may be a container image. In another example, a container object may be associated with a built container, such as an overlay file system of the container. In another example, a container object may be a particular layer of the container, such as a base layer of the container. In another example, a container object may be a base image that is shared by multiple containers. In another example, a container object may be an executable file of the container. In another example, a container object may be a root file system of the container. In another example, a container object may be a library of the container.

As described further herein, in accordance with some implementations, the zero trust microservices platform 160 uses verification result caching to reduce the processing overhead and associated resource footprint associated with container verification. As described further herein, in accordance with example implementations, the zero trust microservices platform 160 stores passing verification results for container objects in a verification results cache of the platform 160. In accordance with example implementations, for purposes of verifying a particular object, the kernel module 191 checks the verification results cache based on container object identifier to determine whether the container object has previously successfully passed verification. If so, then the previous result is used in lieu of undergoing the verification process again. As described further herein, the kernel module 191 invalidates an entry of the verification results cache if the correspond object has been modified.

In accordance with example implementations, some container objects may be designated as being unchangeable, or "immutable." In an example, as further described herein, multiple containers 164 may share a base image that is considered to be immutable. In accordance with example implementations, the kernel module 191 intercepts and blocks API requests that are intended to modify or replace an immutable container object.

In accordance with example implementations, the baseboard management controller 129 includes one or multiple hardware processing cores 184 (e.g., CPU cores) and a memory 180. In an example, the baseboard management controller 129 includes a semiconductor package (or "chip") that contains the processing core(s) 184, as well as possibly includes memory. In an example, in addition to the semiconductor package, the baseboard management controller 129 may include a memory 180 that is external to the semiconductor package and stores machine-readable instructions 182. The instructions 182, in accordance with example implementations, are executed by the processing core(s) 184 to provide components of the zero trust microservices platform 160, such as the operating system kernel 190, the execution control engine 170 and the containers 164. In an example, the semiconductor package may contain additional components of the baseboard management controller 129, which are not depicted in FIG. 1. In examples, these additional components may include one or multiple bus interfaces, registers, a NIC, a hardware-based root of trust engine, tamper detection circuitry, a secure memory, cryptographic accelerators, a one-time-programmable (OTP) fuse memory, a console interface, among other components. Moreover, in accordance with example implementations, one or multiple security-related features of the baseboard management controller 129 may be contained within a secure enclave.

In the context that is used herein, an "engine," such as the execution control engine 170, refers to one or multiple circuits. For example, the circuits may be hardware processing circuits, which can include any or some combination of a microprocessor, a core of a multi-core microprocessor, a microcontroller, a programmable integrated circuit (e.g., a programmable logic device (PLD), such as a complex PLD (CPLD)), a programmable gate array (e.g., field programmable gate array (FPGA)), an application specific integrated circuit (ASIC), or another hardware processing circuit. For the particular example implementation that is depicted in FIG. 1, one or multiple hardware processing cores 184 may execute instructions 182 to perform one or multiple functions for the execution control engine 170, as described herein. Alternatively, an "engine," in accordance with further implementations, such as the execution control engine 170, may be solely limited to one or multiple hardware processing circuits that do not execute machine-readable instructions. In another variation, the execution control engine 170 may be a combination of one or multiple hardware processing circuits and circuits that execute machine-readable instructions.

Referring to FIG. 2, in accordance with example implementations, a baseboard management controller may have a zero trust microservices platform that has a corresponding zero trust microservices architecture 260. In an example, the zero trust microservices platform architecture 260 may correspond to the zero trust microservices platform 160 of FIG. 1. As also depicted in FIG. 2, at any one time, the zero trust microservices platform architecture 260 may be running one or multiple containers 264 to provide microservices corresponding to management-related and/or security-related services for a host on behalf of the baseboard management controller. The containers 264 correspond to trusted containers, and in an example, the containers 264 correspond to the containers 164 of FIG. 1.

The zero trust microservices platform architecture 260 includes a management interface 204 that includes one or multiple container services APIs 206. In the context that is used herein, an application programming interface, or "API," refers to a collection of software components, which collectively provide one or multiple functions, operations or actions. The management interface 204 receives API calls, or requests 201 (called "API requests 201" herein). An API request 201 is directed to invoking one or multiple functions, operations or actions of an API 206. An API 206 may provide a response 202 (called an "API response 202" herein) to an API request 201. In examples, an API response 202 may be an acknowledgement of an API request 201, an indication that an API request 201 was successfully performed, or an indication that an API request 201 was denied.

In an example, an API 206 is an Open BMC server API, and the API 206 receives RESTful Redfish API requests 201 that are directed to container management-related operations. These API request 201 include Redfish schema that denotes container management services. For example, the Redfish schema may include the prefix "redfish/v1/managers/bmc/containerservice/." In other implementations, the API request 201 may be an IOCTL system call, a RESTful API other than a Redfish API request, or request using some other system software proxy.

Responsive to receiving an API request 201, an API 206 routes the API request 201 to an appropriate action handler 208 of the management interface 204. The action handler 208, in accordance with example implementations, converts the API request 201 into a message that is communicated over a message bus 212. In an example, the message bus 212 is a Desktop Bus, or "D-bus." The D-bus is a message-oriented middleware mechanism in Open BMC that enables inter-process communication (IPC). In accordance with example implementations, the message bus 212 interface and message format are defined in a message bus interface library 222 (e.g., a phosphor D-bus library).

In accordance with example implementations, the zero trust microservices architecture 260 includes an execution control engine 270 (corresponding to the execution control engine 170 of FIG. 1) that registers itself to the message bus 212 upon starting. The execution control engine 270 includes a kernel module 272 and a security agent 274, which correspond to the kernel module 191 and the security agent 193, respectively, of FIG. 1. The kernel module 272 is part of an operating system kernel. The kernel module 272 listens for messages on the message bus 212. As described herein, the kernel module 272 processes the messages to ensure that no untrusted container runs on the zero trust microservices platform architecture 260. In accordance with example implementations, the kernel module 272 intercepts run container calls (e.g., crun and runc calls) in the operating system kernel, and the kernel module 272 also intercepts file system calls (e.g., file open with Write mode) that attempt to modify immutable files.

In an example, the Redfish schema for the API requests 201 allows the following API request types for container operations: a run container request, a stop container request, an image pull request, an image load request and an image removal request. The run container request is directed to creating and starting a specific container that is identified by the request. The stop container request is directed to halting a specific container that is identified by the request. The image pull request is directed to transferring an image from a container image registry 228 to a local image store 229 for the baseboard management controller. The image load request is directed to transferring an image to the local image store 229 from a tar archive. The image removal request is directed to deleting, or removing, a specific image from the local image store 229. In an example, the local image store 229 corresponds to a portion of a local memory of the baseboard management controller, such as, in an example, the memory 180 of FIG. 1. Moreover, in accordance with example implementations, the local image store 229 is part of the baseboard management controller's file system.

In accordance with example implementations, an API 206 verifies container image signatures for image pull and image load requests. The verification of a container image includes the API 206 comparing an observed signature (e.g., a hash) for the image to an expected signature, and if the API 206 determines that the observed signature does not match the expected signature, then the verification fails, and the API 206 rejects the image pull request or image load request. Otherwise, responsive to the container image associated with the image pull request or image load request passing verification, the API 206 routes the request to the appropriate action handler 208.

The kernel module 272, in accordance with example implementations, is configured by default to intercept certain container lifecycle operation calls. In an example, the kernel module 272 is configured to intercept all run container requests. The kernel module 272, for an intercepted run container request, first determines whether the container targeted by the request is trustworthy. The kernel module's initial assumption is that the container is untrustworthy and is not allowed to run. This assumption may be overcome by the successful validation of the container. In this manner, the execution control engine 270 verifies one or multiple container objects associated with the container, with the specific container objects that are subjected to verification depending on a particular validation policy 227 that is stored in a policy and signature store 226 of the zero trust microservices platform 260. In an example, the policy and signature store 226 may correspond to a portion of a local memory of the baseboard management controller, such as the memory 180 of FIG. 1.

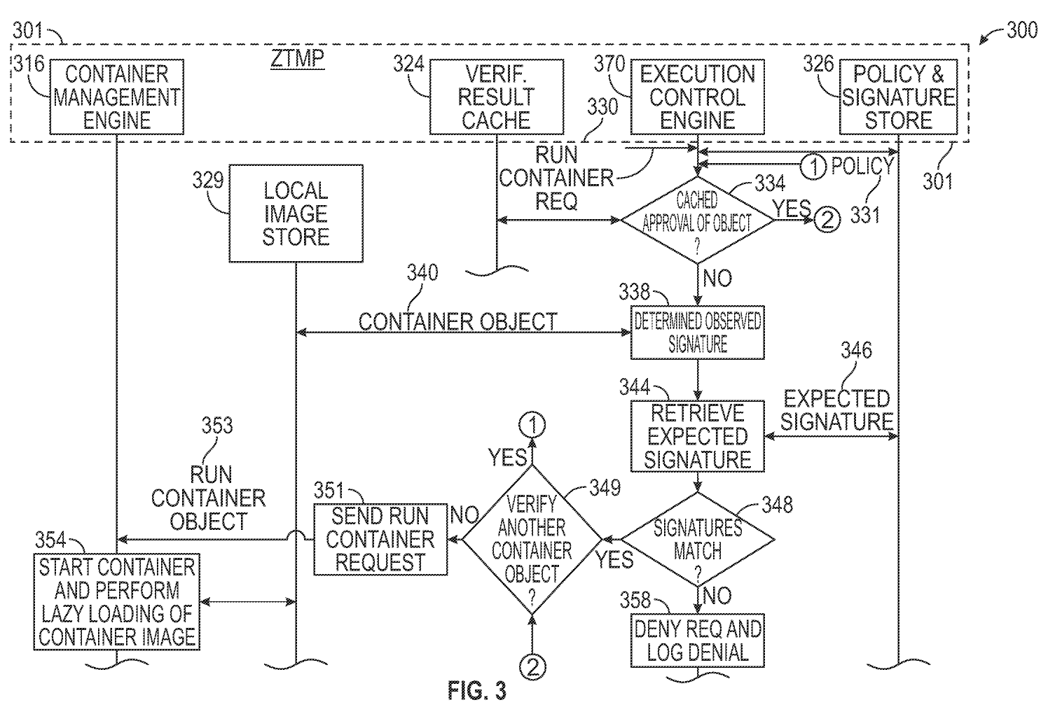

The kernel module 272 may request the security agent 274 to verify a particular container object. For this purpose, the security agent 274 compares an observed signature of the container object to an expected signature for the container object. The security agent 274 communicates the results (e.g., pass or fail) of the container object verification to the kernel module 272. In accordance with example implementations, expected signatures 225 for container objects are stored in the policy and signature store 226. In accordance with some implementations, an expected signature may be a parameter that is provided as part of an API request 201. For example, a run container request may include an expected signature (e.g., an expected signature for a container image) for a container to be run. FIG. 3, which is discussed below, depicts an exemplary sequence flow diagram 300 performed by a zero trust microservices platform to process a run container request, and the processing includes verifying container objects of the container to be run.

Still referring to FIG. 2, if the kernel module 272 determines that all of the container object(s) for the container successfully pass verification, then the kernel module 272 passes the run container request to a container management engine 216 (e.g., a containerd engine) of the zero trust microservices platform architecture 260. The container management engine 216, responsive to the run container request, builds and runs the container 264. An API response 202 is then sent, indicating that the container 264 has started. If, however, a particular container object associated with the targeted container does not pass verification, then the kernel module 272 does not pass the run container request to the container management engine 216, and the run container request is therefore blocked.

Some container objects may be designated as being unchangeable, or immutable. For example, as described below, a base image 230 may be shared by multiple containers 264 and may be designated as being immutable. Although depicted in the image registry 228, the base image 230 may transfer into the local image store 229, where the base image 230 is accessed and used to build multiple containers 264 that share the base image 230. In accordance with example implementations, the kernel module 272 intercepts and blocks all requests that are intended to modify, replace or delete container objects (such as the base image 230), which have been designated as being immutable. In an example, immutable container objects are identified by a particular policy 227 that is stored in the policy and signature store 226. The kernel module 272, in accordance with example implementations, checks each API request 201 against the policy 227 for purposes of determining whether the API request 201 targets an immutable container object.

The kernel module 272 may be configured, by default, to intercept container lifecycle operation calls corresponding to certain call categories (e.g., calls to create, resume or restart containers). For a call corresponding to one of these categories, the kernel module 272 does not allow the call to be forwarded to the container management engine 216 until the kernel module 272 first determines that the targeted container is trusted. The kernel module 272, in accordance with example implementations, may be configured by a policy 227 to intercept container lifecycle operation calls corresponding to other call categories (e.g., configured by policy 227, if at all, to intercept calls to pause, stop and/or remove containers).

A baseboard management controller may be a resource-constrained device. In an example, the baseboard management controller may have limited available CPU, memory and storage resources. In accordance with example implementations, the zero trust microservices platform architecture 260 has features to efficiently manage the resources of a resource-constrained baseboard management controller.

In an example of a feature of the zero trust microservices platform architecture 260 to efficiently manage the resources of a resource-constrained baseboard management controller, in accordance with some implementations, multiple (e.g., all or a less subset) containers 264 share a base image 230. In this context, a "base image" refers to a portion of a container image, which corresponds to one or multiple lower layers of the container image. In an example, the base image 230 contain a root file system. In another example, the base image 230 includes core libraries (e.g., a library for client uniform resource locator (URL) for secure sockets layer (SSL) connections, device access libraries and other libraries to provide developers with basic capabilities for interacting with the baseboard management controller) for the containers 264. Because containers 264 may share the libraries of the base image 230, the sizes of these containers is reduced, as compared to the sizes without base image sharing. The sharing of a base image 230, in general, reduces the storage, memory and CPU footprint of the containers 264.

As depicted in FIG. 2, in accordance with example implementations, a base image 230 may be stored in the image registry 228. In an example, the image registry 228 may be located in a storage device of the computer platform, such as a storage device 109 of FIG. 1. When the zero trust microservices platform architecture 260 is first initialized (e.g., initialized on the boot of the baseboard management controller), the architecture 260 (e.g., the execution control engine 270 or other entity) reads the base image 230 from the image registry 228 and writes the base image 230 into the local image store 229. In accordance with example implementations, the base image 230 is loaded once into the local image store 229 and is thereafter shared among the containers 264.

In addition to minimizing the resource footprints of the containers 264, another advantage of sharing the base image 230 is that the base image 230 is verified only one time. In this manner, in accordance with example implementations, the zero trust microservices platform architecture 260 verifies the signature of the base image 230 responsive to the loading of the base image 230 into the local image store 229. For containers 264 that use the base image 230, the loaded base image 230 is therefore not verified again as part of the pre-run validation of these containers 264.

In addition to the base image 230, the image registry 228 may contain other images 240. In an example, an image 240 may be a full container image for a container 264 that does not share the base image 230. In another example, an image 240 may correspond to a particular container 264 that shares the base image 230, and for this example, this image 240 includes layers other than the layers contained in the base image 230.

In another example of a feature of the zero trust microservices platform architecture 260 to efficiently manage resources of a resource-constrained baseboard management controller, in accordance with some implementations, passing result verification results are stored in a verification results cache 224. In an example, the signature cache 224 corresponds to a portion of a local memory of the baseboard management controller, such as, for example, the memory 180 of FIG. 1. The verification results cache 224 contains a collection of one or multiple entries that correspond to respective key-value pairs 235. In accordance with example implementations, a key-value pair 235 includes a key that corresponds to an identifier for a particular container object (e.g., a full container image, an image corresponding to certain layers of a container, a library, an executable file, a root file system, or other container object). The key-value pair 235 also includes a value that represents whether the associated container object previously passed validation. In this manner, when the security agent 274 determines, based on a comparison of expected and observed signatures, that a particular container object passes verification, the kernel module 272 caches the result by creating the corresponding key-value pair 235 in the verification results cache 224.

The value of a key-value pair 235, in accordance with example implementations, has one state to represent a verification pass and another state to represent a verification fail. In accordance with example implementations, the kernel module 272, as part of the verification of a particular container object, first checks the verification results cache 224 based on the object's identifier for purposes of determining whether the object has already passed verification. If the verification results cache 224 contains a corresponding key-value pair 235 that indicates a passing status, then the kernel module 272 deems the container object to have passed verification. If the key-value pair 235 represents a verification failure, then the kernel module 272 uses the failure result to block the call. In accordance with example implementations, the kernel module 272 requests the security agent 274 to verify the signature of the container object when there is no corresponding key-value pair 235 found in the verification results cache 224.

The kernel module 272, in accordance with example implementations, invalidates a key-value pair 235 entry by removing the key-value pair 235 from the verification results cache 224. The absence of a key-value pair 235 (corresponding to a particular container ID) in the verification results cache 224 forces the kernel module 272 to re-verify the signature for the container object in subsequent container-related operation calls.

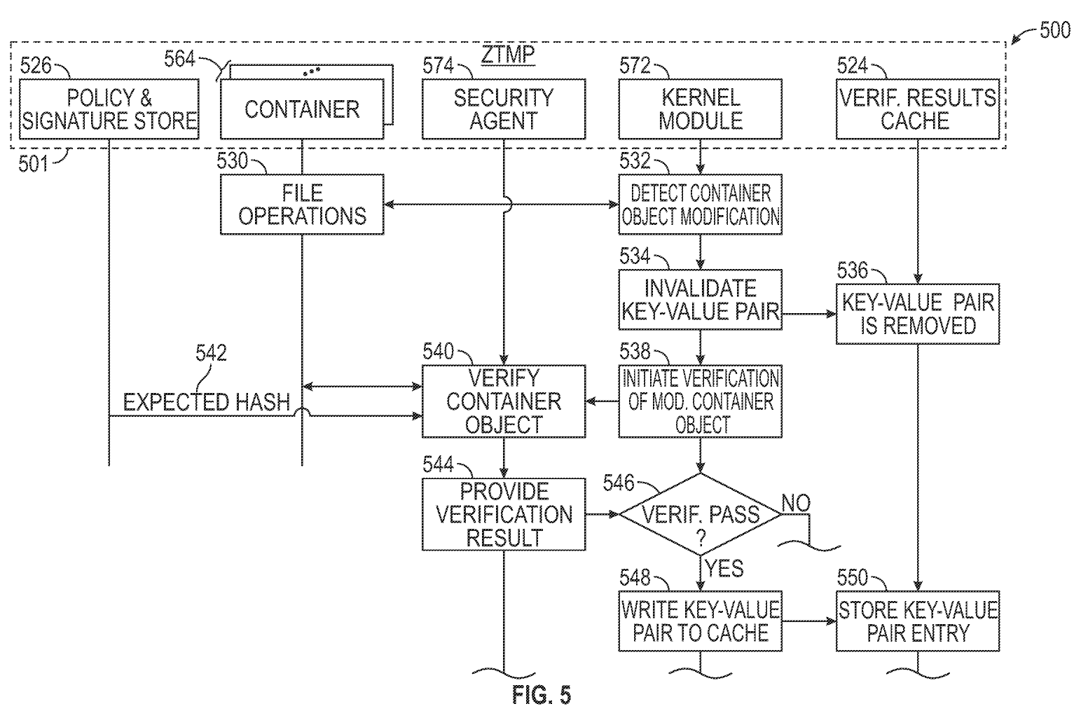

The kernel module 272 monitors for file system operations (e.g., file writing or file removal) that may change a previously-verified container object, and when such events are detected, the kernel module 272 removes the corresponding key-value pair 235 to force a re-verification of the container object. FIG. 5, which is described below, depicts an example sequence flow used by a zero trust microservices platform to detect and manage such file system operations, in accordance with an example implementation.

In another example of a feature to efficiently manage the resources of a resource-constrained baseboard management controller, in accordance with some implementations, a zero trust microservices platform corresponding to the architecture 260 uses memory pooling. With memory pooling, a number of memory blocks (e.g., fixed-sized blocks or variable-sized blocks) are pre-allocated for the components of the zero trust microservices platform. In an example, a memory allocator of an operating system (e.g., the operating system kernel 190 of FIG. 1) may be called in the initial resource allocation for the zero trust microservices platform to create a memory pool for the platform. The pre-allocated blocks may then be dynamically allocated at run time of the zero trust microservices platform by assigning respective handles to the blocks as needed. When a block is deallocated and is returned to the memory pool, then the assigned handle to the block is released.

In another example of a feature to efficiently manage the resources of a resource-constrained baseboard management controller, in accordance with some implementations, a zero trust microservices platform corresponding to the architecture 260 is modularized and composable at build time and run time. In this manner, the zero trust microservices platform may be built to meet the specific resource constraints of the baseboard management controller. In an example, certain functionalities (e.g., a command line interface (CLI) or certain remote management features) of the zero trust microservices platform may be excluded by configuration during build time or run time. This composability allows the zero trust microservices platform to adapt to a wide variety of baseboard management controllers and execution environments.

In another example of a feature to efficiently manage the resources of a resource-constrained baseboard management controller, the zero trust microservices platform, in accordance with some implementations, is streamlined so that the platform does not have any unused components or features. In an example, the container management engine 216 may be an open source container run time management engine, such as a containerd interface, which is modified to remove one or multiple unused components. For example, the containerd interface may be modified to remove the "ctr" component, which is the client command interface of the containerd interface. In addition to conserving resources, the removal of unused components and features reduces the attack surface of the zero trust microservices platform. In accordance with example implementations, one or multiple policies 227 sets forth criteria for building the zero trust microservices platform, for purposes of finely tailoring the inventory of components of the platform and the features of these components to the resource constraints of a specific baseboard management controller. In an example, a policy 227 identifies the components for the zero trust microservices platform. In another example, a policy 227 identifies features of one or multiple components of the platform, such as, for example, identifying whether a containerd interface has a ctr component or certain other features. In this way, a specific inventory of components and specific component features of the zero trust microservices platform may be considered at build time and/or run time to configure the platform for a specific baseboard management controller.

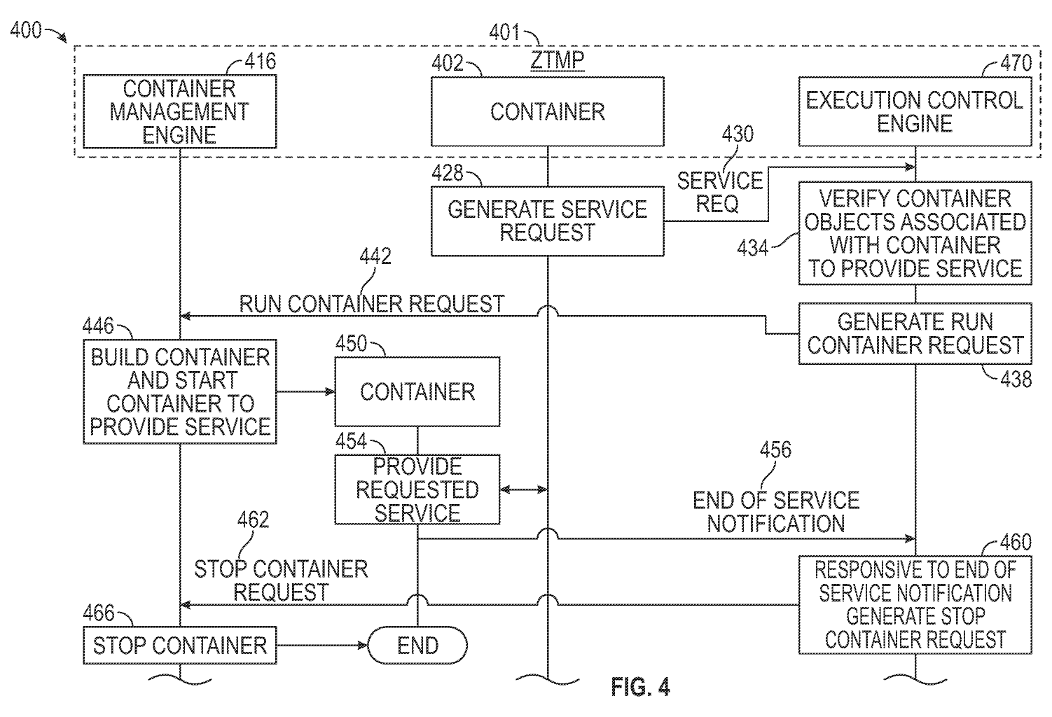

The zero trust microservices platform, in accordance with example implementations, conserves resources of the baseboard management controller through on demand container allocation and lazy loading practices. FIG. 3, which is described below, depicts an example sequence flow diagram 300 to process a run container request, and if the run container request allowed is allowed to proceed, perform lazy loading of the container image. FIG. 4, which is described below, depicts on demand allocation of a container to handle a request and the subsequent deallocation of resources when the request is satisfied. The lazy loading and on-demand loading free up resources of the baseboard management controller, which would otherwise be allocated for unused or idle functions.

FIG. 3 is a sequence flow diagram 300 that depicts the processing of a run container request 330 by a zero trust microservices platform 301, in accordance with example implementations. The zero trust microservices platform 301 includes a container management engine 316, a verification results cache 324, an execution control engine 370 and a policy and signature store 326, which, in an example, correspond to the container management engine 216, the verification results cache 224, the execution control engine 270 and the policy and signature store 226, respectively of FIG. 2. FIG. 3 also depicts a local image store 329 that, in an example, corresponds to the local image store 329 of FIG. 2. In accordance with example implementations, the execution control engine 370 includes a kernel module and a security agent, similar to the kernel module 272 and the security agent 274 of the execution control engine 270 of FIG. 2.

Referring to FIG. 3, the execution control engine 370, in accordance with example implementations, intercepts all run container requests, such as the exemplary run container request 330, for purposes of the execution control engine 370 first verifying whether the container targeted by the run container request 330 can be trusted. If the execution control engine 370 determines that the run container request 330 can be trusted, then the execution control engine 370 passes the run container request 330 to the container management engine 316 for execution. Otherwise, the execution control engine 370 does not pass the run container request to the container management engine 316 and therefore, prevents, or blocks, the running of the container.

For purposes of processing the run container request 330, the execution control engine's initial assumption is that the container targeted by the request 330 is untrustworthy and is not allowed to run on the zero trust microservices platform 301. This assumption may be overcome by the execution control engine's validation of the container. In this manner, the execution control engine 370 validates one or multiple container objects associated with the container, with the specific container objects being subjected to validation depending on a particular validation policy 331. For the example implementation that is depicted in FIG. 3, the execution control engine 370 performs a sequence of iterations to validate the container, with each iteration evaluating a different container object.

As depicted in decision block 334, at the beginning of an iteration corresponding to a particular container object, the execution control engine 370 determines whether the verification results cache 324 contains a cached approval of the container object. If so, then the execution control engine 370 bypasses the process to verify the container object based on the object's observed signature, and control transfers to decision block 349. Otherwise, if the execution control engine 370 determines (decision block 334) that the cached approval is not in the verification results cache 324, then the execution control engine 370 determines the observed signature of the container object, as depicted at 338. In an example, determining the observed signature of the container object includes the execution control engine 370 reading the container object from the local image store 329, as depicted at 340, and applying a cryptographic hash algorithm to the container object to derive a digest, or hash, which corresponds to the observed signature.

In an example, for purposes of applying the cryptographic hash algorithm, the execution control engine 370 may use a cryptographic accelerator of the baseboard management controller. In another example, the execution control engine 370 may request a container-provided service of the zero trust microservices platform 301 to apply a cryptographic hash algorithm to a container object. In another example, the execution control engine 370 determines a signature for a container object by directly applying a cryptographic hash algorithm that is built into the engine 370.

The execution control engine 370 subsequently retrieves the expected signature for the container object, as depicted at 344. As depicted at 346, in an example, retrieving the expected signature of the container object includes reading the expected signature from the policy and signature store 326. In another example, the expected signature may be a parameter that is provided as part of the run container request 330. The execution control engine 370 then determines, as depicted in decision block 348, whether the expected and observed signatures match (e.g., are the same). If so, then the container object passes the verification, then control passes to decision block 349.

Pursuant to decision block 349, the execution control engine 370 determines whether there is another container object to verify for the container. If there is another container object to verify, then, as depicted in FIG. 3, control returns to decision block 334 for another iteration. Otherwise, if the container object passes verification (decision block 348) and there are no more container objects to verify for the container, then the execution control engine 370 sends (block 351) a run container request 353 to the container management engine 316. In an example, the container management engine 316 using lazy loading to conserve the resources that are allocated to run the container. In this manner, as depicted in FIG. 3, in response to the run container request 353, the container management engine 316 loads an initial portion of the container image, starts the container, and loads portions of the container image as requested (e.g., loads an unloaded portion of the container image responsive to an executing process that corresponds to a loaded portion making a request to load the unloaded portion). In another example, lazy loading may not be used, and in response to the run container request 353, the container management engine 316 loads the entire container image and then starts the container.

If the execution control engine 370 determines (decision block 348) that the container object did not pass verification, then the execution control engine 370 denies the request and logs the denial, as depicted at 358. In an example, a logged entry may include data representing the run container request, a time stamp of the request and identification of a container object that failed verification. In accordance with some implementations, the execution control engine 370 may take one or multiple additional actions, such as, for example, sending a notification to a remote management server (e.g., the remote management server 190 of FIG. 1) reporting the denial of the run container request.

FIG. 4 is a sequence flow diagram 400 that depicts on-demand container allocation by a zero trust microservices platform 401, in accordance with example implementations. For this example, the on-demand container allocation involves on demand building and running a container 450 on the zero trust microservices platform 410 to provide a service that is requested by another container 402 that is running on the platform 401. The zero trust microservices platform 401 includes a container management engine 416 and an execution control engine 470, which, in an example, correspond to the container management engine 216 and the execution control engine 270, respectively of FIG. 2. In accordance with example implementations, the execution control engine 470 includes a kernel module and a security agent, similar to the kernel module 272 and the security agent 274 of the execution control engine 270 of FIG. 2.

For the example implementation that is depicted in FIG. 4, the container 402 generates a service request 430 that initiates the lazy loading process and more specifically, initiates the loading and running of the container 450. In an example, the container 402 may provide a microservice corresponding to a service of the baseboard management controller to apply a cryptographic algorithm. In examples, the container 402 may provide a service that relies on encrypting data, decrypting data or applying a cryptographic hash algorithm. For the example that is specifically depicted in FIG. 4, the container 450 provides a microservice corresponding to a cryptographic service, such as encrypting data, decrypting data or applying a cryptographic hash algorithm. In an example, the container 450 provides a microservice corresponding to a service to calculate an observed signature (the output) for a container object (the input).

The service request 430 serves as a trigger to initiate a process to validate, build and run the container 450 for purposes of providing the service requested by the service request 430. After the service is provided, the process continues to stop the container 450 and deallocate the resources that were used for the container 450. Therefore, in response to the service request 430, the execution control engine 470 verifies (block 438) one or multiple container objects associated with the container 450.

For this example, it is assumed that the container 450 passes the validation, and the execution control engine 470 generates (block 438) a run container request 442 and sends the request 442 to the container management engine 416. The container management engine 416, responsive to the run container request 442, builds and starts the container 450, as depicted at 446. As depicted at 454, the container 450 then provides the requested service. In an example, providing the requested service may include the container 400 identifying a cryptographic object (the input), and the container 450 applies a cryptographic hash algorithm, resulting in an observed signature (the output) that the container 450 provides to the container 400.

The completion of the service results in the execution control engine 470 receiving an end of service notification 456 (e.g., a notification observed by the engine 470, a notification sent to the engine 470 by the container 400 or a notification sent to the engine 470 by the container 450). As depicted in block 460, responsive to the end of service notification, the execution control engine 470 sends a stop container request 462 to the container management engine 416, and the container management engine 416, in response to the request 462, stops the container 450, resulting in the deallocation of resources corresponding to the container 450.

In another variation, the on-demand loading may occur in response to an API request (e.g., an API request 201 of FIG. 2) that is received by the zero trust microservices platform 401. In an example, some services of the baseboard management controller may be short term in nature. For example, an API request may request that a container be run that provides a service (e.g., a cryptographic signing service) that produces an end result and after producing the service, remains idle. For a request to run a container that provides a short term service, the zero trust microservices platform 401 allocates resources for the container by building and running the container when requested, and stopping the container responsive to the container concluding the short term service.

FIG. 5 is a sequence flow diagram 500 depicting actions and communications of components of a zero trust microservices platform 501 responsive to a container object being modified, according to an example implementation. The zero trust microservices platform 501 includes running containers 564, a policy and signature store 526, a security agent 574, a kernel module 572 and a verification results cache 524 similar to the containers 264, the policy and signature store 226, the security agent 274, the kernel module 272 and the verification results cache 224, respectively, of FIG. 2. In an example, the kernel module 572 and the security agent 574 may be part of an execution control engine of the zero trust microservice platform 501, corresponding to, for example, the execution control engine 270 of FIG. 2.

The kernel module 572 monitors file operations 530 of the containers 564 for purposes of detecting any file operation that modifies a container object corresponding to a container 564. As depicted at 532, the kernel module 572 detects a file operation that targets a particular container object, and the kernel module 572 proceeds to invalidate the key-value pair associated with the container object, as depicted at 534. As depicted at 536, in accordance with example implementations, the kernel module 572 invalidates the key-value pair by removing the key-value pair from the verification results cache 524.

The invalidation of the key-value pair forces re-verification of the container object. As depicted at 538, the kernel module 572 initiates a re-verification of the of the container object by requesting the security agent 574 to verify the container object. For this purpose, the security agent 574 applies a cryptographic hash algorithm to the container object to determine a corresponding observed hash (or "expected signature") for the container object. Moreover, the security agent 574 compares the observed hash to an expected hash 542 for the container object, such as an expected hash that is stored in the policy and signature store 526. As depicted at 544, the security agent 574 provides, to the kernel module 572, a verification result, which represents whether or not the container object passed verification.

As depicted in decision block 546, the kernel module 572 determines, based on the verification result that is provided by the security agent 574, whether the container object passed verification. If the container object passed verification, then the kernel module 572, as depicted at 548, writes the corresponding key-value pair to the verification results cache 524. In an example, the key-value pair contains a key that corresponds to the container object's container ID and a value that represents that the container object passed verification. As depicted at 550, the verification results cache 524 stores the key-value pair entry. If the kernel module 572 determines that the container object did not pass verification, then the kernel module 572 does not update the verification results cache 524. The kernel module 572 may perform one or additional actions responsive to the container object failing verification, such as, for example, updating a log with an entry to record the unsuccessful verification of the container object.

In the context that is used herein, a "hash" (which may also be referred to by such terminology as a "digest," "hash value," or "hash digest") is produced by the application of a cryptographic hash algorithm to an input value. Applying a hash algorithm to an input value may also be referred to herein as determining a "hash" of the input value or "hashing" the input value. A cryptographic hash algorithm receives an input value, and the cryptographic hash algorithm generates a hexadecimal string (the digest, or hash) to match the input value. In an example, the input value may include a string of data (for example, a data structure in memory denoted by a starting memory address and an ending memory address). In such an example, based on the string of data, the cryptographic hash algorithm outputs a hexadecimal string (the digest, or hash). Any minute change to the input value alters the output hexadecimal string. In examples, the cryptographic hash function may be a secure hash algorithm (SHA), a Federal Information Processing Standards (FIPS)-approved hash algorithm, a National Institute of Standards and Technology (NIST)-approved hash algorithm, or any other cryptographic hash algorithm. In some examples, instead of a hexadecimal format, another format may be used for the string.

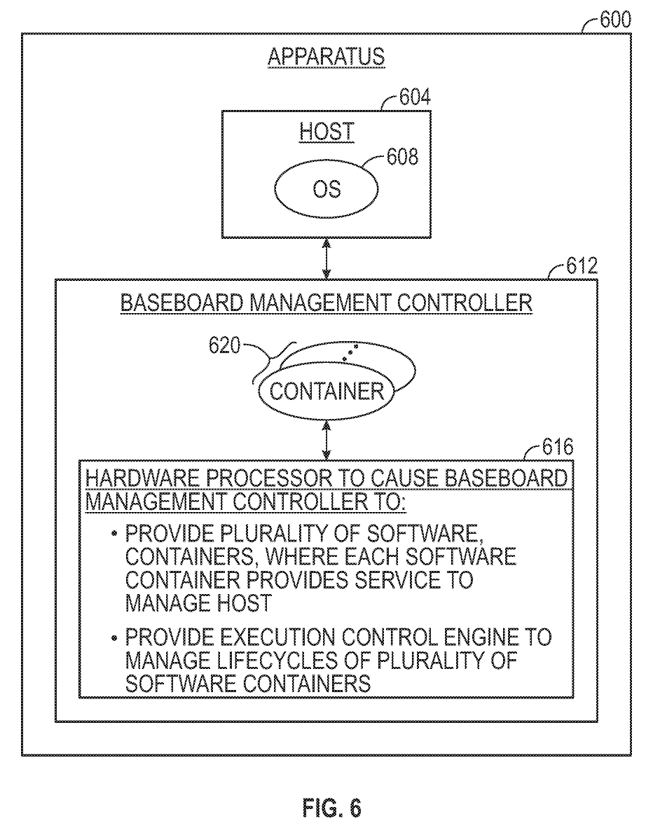

Referring to FIG. 6, in accordance with example implementations, an apparatus 600 includes a host 604 and a baseboard management controller 612. In an example, the apparatus 600 may be a computer platform, such as a server, a network device or other processor-based device. In an example, the baseboard management controller 612 is a specialized service processor subsystem that is mounted to a motherboard of the apparatus 600. In an example, the baseboard management controller 612 includes one or multiple CPU cores and a memory. In an example, the baseboard management controller 612 has an operating system. In an example, the operating system may be a LINUX operating system.

The host 604 is associated with an operating system 608, and the baseboard management controller 612 operates independently from the operating system 608. In an example, the operating system 608 is a LINUX operating system. In an example, an operating system kernel of the baseboard management controller 612 includes a kernel module that intercepts certain container lifecycle operation calls (e.g., calls to run, start, create, restart and resume containers) and does not allow any of these container lifecycle operation calls to be executed until the containers targeted by the calls are successfully validated. In an example, validating a container includes verifying one or multiple container objects that are associated with the container. In an example, for purposes of verifying a container object, the kernel module may check a verification results cache of the baseboard management controller 612 for purposes of determining whether the cache contains an entry that represents that the container object has been successfully verified.

In another example, the kernel module may request a security agent of the baseboard management controller 612 to verify a container object. In an example, the security agent is a daemon that is external to the baseboard management controller's operating system. In an example, the security agent may verify a container object by comparing an expected signature for the container object against an observed signature of the container object. In an example, the expected and observed signatures are hashes. In an example, the observed signature is provided as part of a request for a container operation. In another example, the security agent applies a cryptographic hash algorithm to the container object to derive the observed signature.

The baseboard management controller 612 includes a hardware processor 616. In an example, the hardware processor 616 executes machine-readable instructions, such as firmware instructions. The hardware processor 616 causes the baseboard management controller 612 to provide a plurality of software containers. Each software container provides a service to manage the host 604.

In an example, the service may be a management-related service. In an example, the management-related service may monitor an operating system. In another example, the management-related service may detect and/or initialize resources of the apparatus 600. In another example, the management-related service may monitor sensors (e.g., temperature sensors, cooling fan speed sensors, as well as other sensors) of the apparatus 600. In another example, the management-related service may be a service to report out-of-range sensor readings. In another example, the management-related service may be a service to log computer system events. In another example, the management related service may be remotely-managed. In an example, the management-related service may be a keyboard video mouse (KVM) service, a virtual power function service, or a service to manage virtual media.

In another example, the services provided by the software containers include one or multiple security-related services. In an example, a security-related service validates firmware. In an example, a security-related service securely stores cryptographic artifacts. In an example, a security-related service applies a cryptographic hash algorithm. In an example, a security-related service performs encryption. In an example, a security-related service performs decryption. In an example, a security-related service detects tampering. In an example, a security-related service protects the apparatus 600 against a security intrusion.

The hardware processor 616 causes the baseboard management controller 612 to provide an execution control engine to manage lifecycles of the software containers. In an example, the execution control engine includes the kernel module and the security agent. In an example, managing the lifecycles of the software containers includes regulating when a software container is allowed to run. In other examples, managing the lifecycles of the software containers includes regulating when a software container is allowed to be created, start, resume or restart. In an example, a software container may be a multiple layer structure that includes one or multiple libraries. In another example, a software container may include one or multiple executable files. In an example, the software containers may share a base image. In an example, the baseboard management controller 612 providing the software containers includes the baseboard management controller 612 verifying that the software containers can be trusted. In an example, the baseboard management controller 612 designates one or multiple container objects as being immutable. In an example, the execution control engine blocks intended modifications, or deletions of immutable container objects.

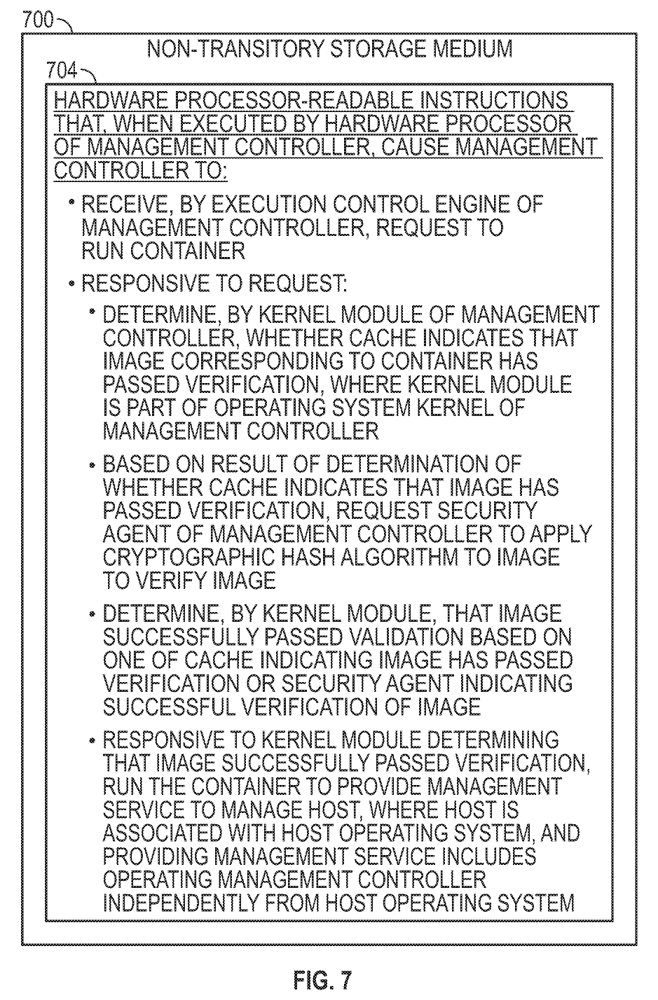

Referring to FIG. 7, in accordance with example implementations, a non-transitory storage medium 700 stores hardware processor-readable instructions 704. The instructions 704, when executed by a hardware processor, cause the management controller to receive, by an execution control engine of the management controller, a request to run a container. In an example, the management controller is a specialized service processor subsystem that is mounted to a motherboard of a computer platform. In an example, the management controller includes one or multiple CPU cores and a memory. In an example, the management controller has an operating system. In an example, the operating system may be a LINUX operating system. In an example, a container may be a multiple layer structure that includes one or multiple libraries. In another example, a container may include one or multiple executable files.

The instructions 704, when executed by the hardware processor, further cause the management controller to, responsive to the request, determine, by a kernel module of the management controller, whether a cache indicates that an image corresponding to the first container has passed verification. The kernel module is part of an operating system kernel of the management controller. The instructions 804, when executed by the hardware processor, further cause the management controller to, responsive to the request, based on a result of the determination of whether the cache indicates that the image has passed verification, request a security agent of the management controller to apply a cryptographic hash algorithm to the image to verify the image. In an example, validating the image is part of a process to determine whether the container is to be trusted. In an example, validating the image includes the security agent determining an observed signature (e.g., a cryptographic hash) of the object and comparing the observed signature to an expected signature for the container object. In an example, if the observed and expected signatures match, then the image passes validation.

In an example, the cache is a verification results cache that stores key-value entries corresponding to verification results for certain container object identifiers. In an example, for purposes of verifying a particular container object, the kernel module first checks the verification results cache for a corresponding key-value pair, and if such a valid key-valid pair exists in the cache and indicates a verification pass for the container object, then the verification of the object is complete. Otherwise, in an example, the kernel module requests the security agent to verify the container object, and the security agent compares an observed signature of the container object to an expected signature for the container object. In an example, the kernel module invalidates a given key-value pair responsive to the modification, addition of or removal of an associated container object. The invalidation may involve changing a verification pass status to a verification fail status.

The instructions 704, when executed by the hardware processor, further cause the management controller to determine, by the kernel module, that the image successfully passed validation based on one of the cache indicating that the image has passed verification or the security agent indicating successful verification of the image. The instructions 704, when executed by the hardware processor, further cause the management controller to, responsive to the kernel module determining that the image successfully passed verification, run the container to provide a management service to manage a host. The host is associated with a host operating system. Providing the management service includes operating the management controller independently from the host operating system.

In examples, the management service is a service to detect or initialize a resource of the host. In other examples, the management service monitors sensors (e.g., temperature sensors, cooling fan speed sensors) and reports out-of-range sensor readings. In another example, the management service logs computer system events. In another example, the management service is a remotely-managed service. In another example, the management service is a keyboard video mouse (KVM) service. In another example, the management service is a virtual power service. In another example, the management service manages virtual media.

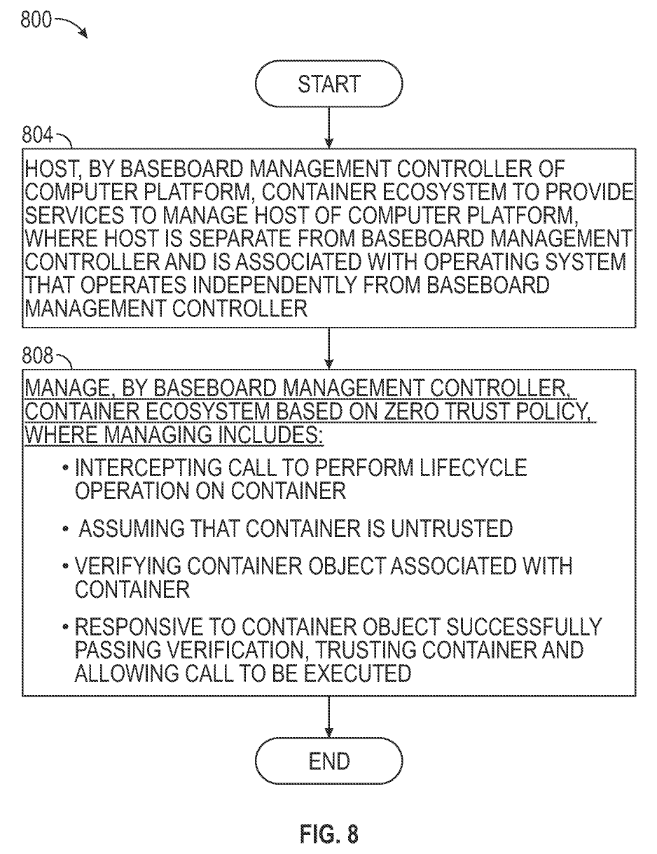

Referring to FIG. 8, in accordance with example implementations, a technique 800 includes hosting (block 804) by a baseboard management controller of a computer platform, a container ecosystem to provide services to manage a host of the computer platform. In an example, the container ecosystem is an execution environment that does not trust any container until the container is validated. In an example, the container ecosystem is an execution environment that does not allow any container to run until the container is validated. In an example, the baseboard management controller is a specialized service processor that is mounted to a computer platform motherboard. In an example, the baseboard management controller includes one or multiple CPU cores and a memory. In an example, the baseboard management controller executes an operating system to provide the container ecosystem. In an example, a security module of the operating system provides the container ecosystem.

In an example, the service may be a management-related service. In an example, the management-related service may monitor an operating system. In another example, the management-related service may detect and/or initialize resources of the computer platform. In another example, the management-related service may monitor sensors (e.g., temperature sensors, cooling fan speed sensors, as well as other sensors) of the computer platform. In another example, the management-related service may be a service to report out-of-range sensor readings. In another example, the management-related service may be a service to log computer system events. In another example, the management-related service may be remotely-managed. In an example, the management-related service may be a keyboard video mouse (KVM) service, a virtual power function service, or a service to manage virtual media.

In another example, the service may be a security-related service. In an example, a security-related service validates firmware. In an example, a security-related service securely stores cryptographic artifacts. In an example, a security-related service applies a cryptographic hash algorithm. In an example, a security-related service performs encryption. In an example, a security-related service performs decryption. In an example, a security-related service detects tampering. In an example, a security-related service protects the computer platform against a security intrusion.

The host is separate from the baseboard management controller and is associated with an operating system that operates independently from the baseboard management controller. The technique 800 includes managing (block 908), by the baseboard management controller, the container ecosystem based on a zero trust policy. In an example, managing the container ecosystem based on a zero trust policy includes assuming that no container is trustworthy until the container is validated. In an example, managing the container ecosystem based on a zero trust policy includes, in response to a run container request, verifying one or multiple objects associated with a container targeted by the request, and allowing the container to run responsive to all of the container objects successfully passing the verifications.

In accordance with example implementations, managing the container ecosystem includes intercepting a call to perform a lifecycle operation on a container. In examples, the lifecycle operation is an operation to create, start, run or resume a container. Managing the container ecosystem further includes assuming that the container is untrusted and verifying a container object associated with the container. In examples, the container object may be a container image, an executable file, a library or a file system. Managing the container ecosystem further includes, responsive to the container object successfully passing the verification, trusting the container and allowing the call to be executed.

In accordance with example implementations, the hardware processor further causes the baseboard management controller to receive an application programming interface (API) request directed to a requested container operation. The hardware processor causes the baseboard management controller to regulate whether the baseboard management controller executes the requested container operation. Among the potential benefits, a platform is provided to efficiently manage resources on a resource-constrained baseboard management controller and ensure that trusted containers are hosted by the baseboard management controller.

In accordance with example implementations, the requested container operation includes an operation for the baseboard management controller to run a given container. The given container is associated with the container image. The hardware processor further causes the baseboard management controller to determine an observed signature for the container image; compare the observed signature to an expected signature for the container image; and allow the container to run responsive to the observed signature matching the expected signature. Among the potential benefits, a platform is provided to efficiently manage resources on a resource-constrained baseboard management controller and ensure that trusted containers are hosted by the baseboard management controller.

In accordance with example implementations, the requested container operation is an operation for the baseboard management controller to run a given container. The given container is associated with a container image. The hardware processor further causes the baseboard management controller to check a verification results cache of the baseboard management controller to determine whether the verification results cache comprises an entry indicating that the container image previously passed verification; and responsive to the verification results cache indicating that the container image previously passed verification, allow the container to run. Among the potential benefits, a platform is provided to efficiently manage resources on a resource-constrained baseboard management controller and ensure that trusted containers are hosted by the baseboard management controller.

In accordance with example implementations, the hardware processor to further, responsive to a modification of the container image, invalidate the entry indicating that the container image previously passed verification. Among the potential benefits, a platform is provided to efficiently manage resources on a resource-constrained baseboard management controller and ensure that trusted containers are hosted by the baseboard management controller.

In accordance with example implementations, the hardware processor is to further perform on-demand container loading. Performing the on-demand container loading includes, responsive to a request for a given service, starting a given software container to provide the service; and responsive to the service being provided to satisfy the request, stopping the given software container. Among the potential benefits, a platform is provided to efficiently manage resources on a resource-constrained baseboard management controller and ensure that trusted containers are hosted by the baseboard management controller.

In accordance with example implementations, the baseboard management controller is to receive an application programming interface (API) request directed to a given service. The given service requests a second service. The hardware processor further causes the baseboard management controller to perform on-demand container loading. Performing the on-demand container loading includes, responsive to the given service requesting the second service, starting a given software container to provide the second service; and responsive to the completion of the second service, stopping the given container. Among the potential benefits, a platform is provided to efficiently manage resources on a resource-constrained baseboard management controller and ensure that trusted containers are hosted by the baseboard management controller.

In accordance with example implementations, the software containers share a base image associated with a plurality of libraries. The baseboard management controller further includes a memory to store a copy of the base image. Among the potential benefits, a platform is provided to efficiently manage resources on a resource-constrained baseboard management controller and ensure that trusted containers are hosted by the baseboard management controller.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms "a," "an," and "the" are intended to include the plural forms as well, unless the context clearly indicates otherwise. The term "plurality," as used herein, is defined as two or more than two. The term "another," as used herein, is defined as at least a second or more. The term "connected," as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term "and/or" as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term "includes" means includes but not limited to, the term "including" means including but not limited to. The term "based on" means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. An apparatus comprising:
a host associated with an operating system; and
a baseboard management controller to operate independently from the operating system to manage the host, wherein the baseboard management controller comprises a hardware processor to cause the baseboard management controller to:
provide a plurality of software containers, wherein each software container provides a management service to manage the host; and
provide an execution control engine to manage lifecycles of the plurality of software containers.

2. The apparatus of claim 1, wherein the hardware processor to further cause the baseboard management controller to:
receive an application programming interface (API) request directed to a requested container operation; and
regulate whether the baseboard management controller executes the requested container operation.

3. The apparatus of claim 2, wherein:
the requested container operation comprises an operation for the baseboard management controller to run a given container;
the given container is associated with a container image;
the hardware processor further causes the baseboard management controller to:
determine an observed signature for the container image;
compare the observed signature to an expected signature for the container image; and
allow the container to run responsive to the observed signature matching the expected signature.

4. The apparatus of claim 2, wherein:
the requested container operation comprises an operation for the baseboard management controller to run a given container; the given container is associated with a container image; and the hardware processor further causes the baseboard management controller to:
check a verification results cache of the baseboard management controller to determine whether the verification results cache comprises an entry indicating that the container image previously passed verification; and responsive to the verification results cache indicating that the container image previously passed verification, allow the container to run.

5. The apparatus of claim 4, wherein the hardware processor to further, responsive to a modification of the container image, invalidate the entry.

6. The apparatus of claim 1, wherein the hardware processor to further perform on-demand container loading, wherein performing on-demand container loading comprises, responsive to a request for a given service:
starting a given software container to provide the service; and responsive to the service being provided to satisfy the request, stopping the given software container.

7. The apparatus of claim 1, wherein:
the baseboard management controller to receive an application programming interface (API) request directed to a given service of the services provided by the plurality of containers; the given service requesting a second service; and the hardware processer further causes the baseboard management controller to perform on-demand container loading, wherein performing on-demand container loading comprises, responsive to the given service requesting the second service:
starting a given software container to provide the second service; and responsive to completion of the second service, stopping the given container.

8. The apparatus of claim 1, wherein:
the software containers of the plurality of software containers share a base image associated with a plurality of libraries.

9. The apparatus of claim 1, wherein the execution control engine comprises an operating system kernel-based module to manage the lifecycles of the plurality of software containers and a security agent to verify signatures of container objects associated with the plurality of software containers.

10. The apparatus of claim 1, wherein the hardware processor to further cause the baseboard management controller to:
receive an application programming interface (API) request directed to running another software container, wherein the API request comprises a parameter representing an expected signature for the other software container; and validate the other software container based on the expected signature.

11. A non-transitory storage medium that stores hardware processor-readable instructions that, when executed by a hardware processor of a management controller, cause the management controller to:
receive, by an execution control engine of the management controller, a request to run a first container; and
responsive to the request:
determine, by a kernel module of the management controller, whether a cache indicates that an image corresponding to the first container has passed verification, wherein the kernel module is part of an operating system kernel of the management controller; based on a result of the determination of whether the cache indicates that the image has passed verification, request a security agent of the management controller to apply a cryptographic hash algorithm to the image to verify the image; determine, by the kernel module, that the image successfully passed validation based on one of the cache indicating the image has passed verification or the security agent indicating successful verification of the image; and responsive to the kernel module determining that the image successfully passed verification, run the first container to provide a management service to manage a host, wherein the host is associated with a host operating system other than the management operating system kernel of the management controller, and providing the management service comprises operating the management controller independently from the host operating system.

12. The storage medium of claim 11, wherein the management controller comprises a baseboard management controller.

13. The storage medium of claim 11, wherein the instructions, when executed by the management controller, further cause the management controller to:
determine a first signature of the image; compare the first signature to a reference signature; and validate the image responsive to a result of the comparison.

14. The storage medium of claim 11, wherein:
the running of the first container provides a request for a second service; and
the instructions, when executed by a management controller, further cause the management controller to, responsive to the request for the service:
validate a second image corresponding to a second container;
responsive to successful validation of the second image, run the second container to provide the second service; and
responsive to the second container completing the second service, stop the second container.

15. The storage medium of claim 14, wherein the second service comprises a cryptographic service.

16. A method comprising:
hosting, by a baseboard management controller of a computer platform, a container ecosystem to provide services to manage a host of the computer platform, wherein the host is separate from the baseboard management controller and is associated with an operating system that operates independently from the baseboard management controller; and managing, by the baseboard management controller, the container ecosystem based on a zero trust policy, wherein the managing comprises:
intercepting a call to perform a lifecycle operation on a container; assuming that the container is untrusted; verifying a container object associated with the container; and responsive to the container object successfully passing the verification, trusting the container and allowing the call to be executed.

17. The method of claim 16, further comprising:
receiving an application programming interface (API) call directed to run the container in the container ecosystem; and responsive to the API call:
verifying an image associated with the container; and selectively loading and running the container responsive to a result of the verification.

18. The method of claim 17, wherein the loading comprises performing lazy loading of a container image associated with the container responsive to the verifying indicating successful verification of the container.

19. The method of claim 16, wherein the hosting comprises at load time or build time:
determining, based on a configuration policy, a configuration for the ecosystem, wherein the configuration comprises at least one of an identification of infrastructure components of the ecosystem or an identification of features of an infrastructure component of the ecosystem; and building the ecosystem based on the configuration.

20. The method of claim 16, wherein the hosting comprises allocating memory for containers of the container ecosystem from a memory pool.
